(19) United States
(12) Patent Application Publication
(10) Pub. No.: US 2014/0083922 A1
(43) Pub. Date: Mar. 27, 2014

(54) ANTI-ROTATION KNURLS

(71) Applicant: Cummins Filtration IP, Inc., Columbus, IN (US)

(72) Inventors: Bryan A. Lynchard, Cookeville, TN (US); Ismail C. Bagci, Cookeville, TN (US); Aaron M. Wells, Cookeville, TN (US); James L. Eickhoff, Evansville, IN (US)

(73) Assignee: Cummins Filtration IP, Inc., Columbus, IN (US)

(21) Appl. No.: 14/039,396

(22) Filed: Sep. 27, 2013

Related U.S. Application Data
(60) Provisional application No. 61/706,195, filed on Sep. 27, 2012.

(51) Int. Cl. B01D 29/00

(52) U.S. Cl. CPC B01D 29/0063; B01D 29/0093
USPC 210/236; 29/505

(57) ABSTRACT

A filter assembly that includes a shell having anti-rotation features that prevent rotation of the shell relative to the nutplate and a method for producing the disclosed filter assembly are described. The anti-rotation features are knurls and/or surface disruptions that are formed on a surface of a flange on an open end of the shell. The knurls and/or surface disruptions that are formed on a surface on the flange can aid in gripping a surface of an upper groove of the nutplate.

### FIELD

This disclosure relates generally to fluid filtration, and more particularly to a filter assembly that includes a shell and a nutplate.

### BACKGROUND

A known type of filter assembly used in a vehicle engine such as a diesel engine includes a filter housing or shell, a filter cartridge that is disposed within the filter housing and a nutplate for closing an open end of the filter housing.

In these types of filter assemblies, the nutplate is usually provided with both an upper groove and a lower groove on an outer edge. The lower groove is configured to seat an O-ring, while the upper groove circumscribes the upper portion of the filter housing.

A roll forming operation is usually performed to deform the filter housing into the upper groove of the nutplate. This roll forming operation is typically followed by a secondary operation such as a staking operation to stake the housing into the groove to prevent the filter housing from slipping or rotating relative to the nutplate during filter installation or removal.

### SUMMARY

A filter assembly that includes a shell having anti-rotation features that prevent rotation of the shell relative to the nutplate and a method for producing the disclosed filter assembly are described.

In one embodiment, the anti-rotation features are knurls and/or surface disruptions that are formed on a surface of a flange on an open end of the shell. The term “knurls and/or surface disruptions” herein means ridges or grooves on a surface of a component that can aid in gripping, for example, a surface of another component.

The knurls and/or surface disruptions that are formed on a surface, for example, on the flange of the shell can aid in gripping a surface, for example, of an upper groove of the nutplate.

The disclosed method involves the formation of knurls and/or surface disruptions that does not utilize a secondary operation such as a staking operation to stake selected edge portions.

The filter assembly described herein can be used in automotive/diesel truck engines for filtering various engine fluids including but not limited to fuels such as diesel fuel, oils, and hydraulic fluids. In one embodiment, the disclosed filter assembly includes a housing, which is also referred to as a shell, having a side wall, a base portion, an open end and an interior space and a nutplate, which is also referred to as a retainer, having fluid inlet openings that extend through the nutplate and direct fluid to be filtered into the interior space, a hub having an opening through which filtered fluid exits the filter assembly, and a sidewall. The sidewall of the nutplate is provided with a first groove. The housing further includes a flange proximate to the open end that is disposed within the first groove and substantially conforms to the shape of the groove. The flange has an inner surface and an outer surface. The inner surface of the flange is in contact with the surface of the first groove of the nutplate.

In some examples, the inner surface of the flange has knurls and/or surface disruptions that aid in gripping the surface of the first groove of the nutplate. The knurls and/or surface disruptions on the inner surface of the flange form the anti-rotation features that prevent rotation of the housing relative to the nutplate.

In one embodiment of the method of forming the disclosed filter assembly, a knurl wheel is used to form the knurls and/or surface disruptions on the inner surface of the flange of the housing. In some examples, a seamer machine is utilized for performing a seaming operation. In one example, a profile roll is advanced into a flange of the housing that is adjacent to the first groove on the nutplate using a servo actuator within the seamer machine. The seaming operation is then performed so that the profile roll engages the flange of the shell, and the servo actuator follows the shape the first groove of the nutplate such that the flange is radially deformed to conform the flange to the shape of the first groove. In some examples, the seaming operation results in the knurls and/or surface disruptions being embedded into the surface of the first groove of the nutplate.

In some examples, the knurl and/or surface disruption can be implemented in a stamping operation of the shell itself. This would eliminate, for example, the need for an additional operation after the stamping operation of the shell. In some examples, the knurls and/or surface disruptions can be a radial arrangement of surface protrusions surrounding the flange. In some example, the number of surface protrusions is an amount sufficient to meet a required torque retention specification(s) of the nutplate and the shell interface.

### BRIEF DESCRIPTION OF THE DRAWINGS

FIG. 1A is a cross-sectional side view of the assembled filter assembly.

FIG. 1B is an enlarged view of the dotted outline area in FIG. 1A.

FIGS. 2A, 2B and 2C are top plan views of discrete patterns of grooved and ungrooved surfaces defined by knurls and/or surface disruptions that can be provided on an inner surface of a flange.

FIG. 3 is a cross sectional side view of the knurls and/or surface disruptions shown in FIG. 2C.

FIG. 4 illustrates one embodiment of the disclosed method.

FIG. 5 shows a partial cross-sectional side view of the housing and nutplate before deformation.

FIG. 6 shows a perspective view of a knurl wheel and housing.

Each of FIGS. 7A, 7B, 7C, 7D and 7E shows a perspective view of an example of a knurl wheel that can be used in the disclosed method.

FIG. 8 shows a perspective view of a housing and profile roll.

### DETAILED DESCRIPTION

A filter assembly having anti-rotation features that prevent rotation of a shell relative to a nutplate and a method of forming the disclosed filter assembly are described. The concepts described herein will be described with respect to a fuel filter assembly in a diesel engine. However, in appropriate circumstances, it is to be realized that the concepts can be applied to other types of filter assemblies as well. In addition, the fluid used can include any vehicle fluids including, but not limited to, oil, fuel such as diesel fuel, hydraulic fluid, etc.

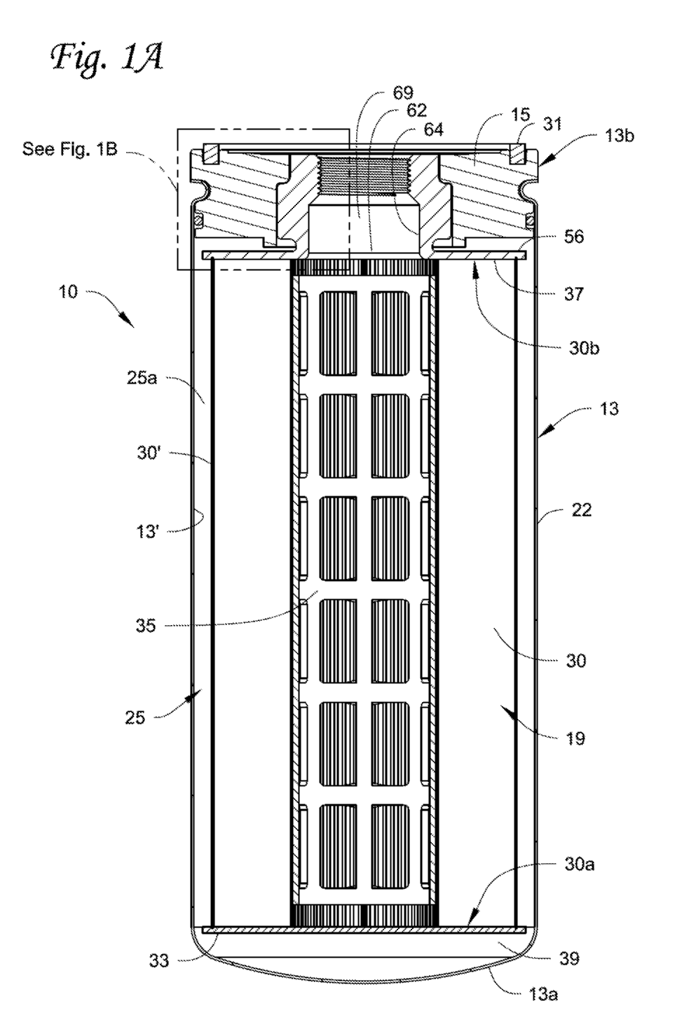

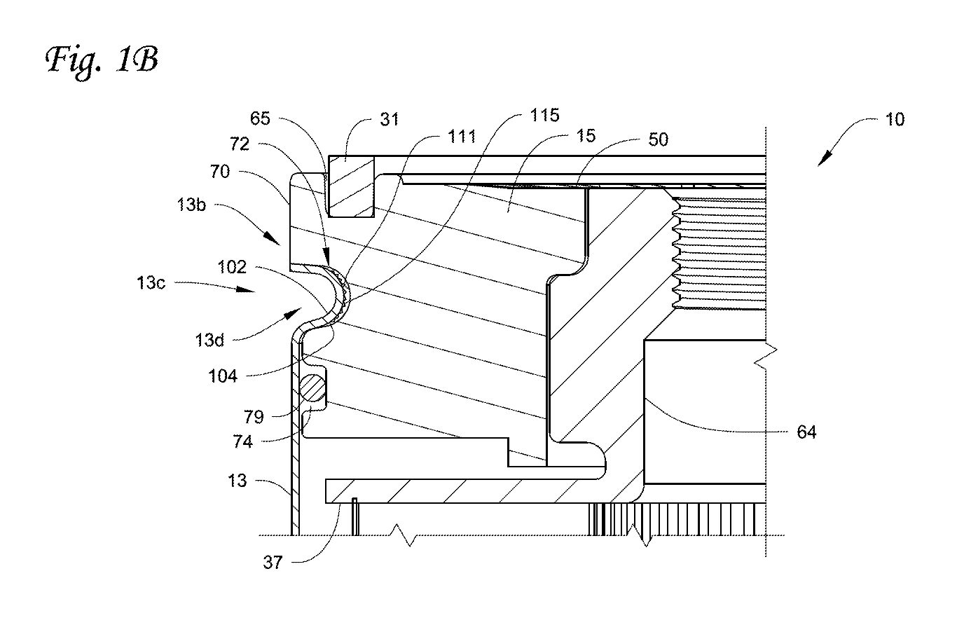

Referring to FIGS. 1A and 1B, a filter assembly 10 includes a housing 13, a nutplate 15 and a filter element 19. The housing 13 is hollow and cylindrical in shape. The housing 13 has a closed end 13a, an open end 13b, a sidewall. 22 and an interior space 25. FIG. 1A shows the housing 13 as being cylindrical, but in appropriate circumstance, the housing 13 could have different shapes. In addition. the material of the housing 13 can be formed of any material that is suitable for forming a shell on a filter assembly, including, but not limited to, aluminum, steel, etc.

A filter element 19 includes a filter media 30, a bottom end plate 33 and a top end plate 37. The filter media 30 can be any filter media that is suitable for filtering fluid with which the disclosed filter assembly is to be used.

The filter media 30 is generally cylindrical and surrounds a center tube 35 which functions to retain the geometrical shape of the filter media 30. During use, an unfiltered fluid enters a space 25a defined between the inner surface 13′ of the housing 13 and the outer region 30′ of the filter media 30, and flows through the filter media 30 toward the center tube 35 so as to filter the fluid.

The bottom endplate 33 is secured to a bottom end 30a of the filter media 30 and is substantially circular. The bottom endplate 33 is provided to prevent filtered fluid from passing to a bottom space 39 of the housing 13 from the center tube 35.

The top endplate 37 is secured to a top end 30b of the filter media 30. The top end plate 37 includes a base plate 56 that is substantially circular and a central opening 62. A sleeve 64 extends upwardly from the edge of the central opening 62 towards the open end 13b of the housing 13 so as to define a flow passageway 69. During use, fluid filtered by the filter media 30 flows through the central opening 62, and into the flow passageway 69 and out the sleeve 64 to an engine.

The material of the bottom endplate 33 and the top endplate 37 can be any material that is suitable for use with the disclosed filter assembly, including, but not limited to, metal, composite, plastic, etc. In addition, the filter media 30 can be secured to the bottom endplate and the top endplate 37 by any means, including, but not limited to adhesives, etc.

The open end 13b of the housing 13 receives the nutplate 15, which may also be referred to as a retainer. The nutplate 15 includes a hub 50 that receives the sleeve 64 of the top end plate 37 such that the nutplate 15 can be removably mounted to the filter element 19. The nutplate 15 further includes a plurality of ribs (not shown) between the hub 50 and a sidewall 70 of the nutplate 15. The plurality of ribs define fluid inlet openings (not shown) that extend through the nutplate 15 and direct fluid to be filtered into the interior space 25. A gasket groove 65 is formed in the top surface of the nutplate 15, and a gasket 31 seats within the groove 65 and functions to seal, for example, a surface surrounding a spud of a diesel engine.

The nutplate 15 can be made of any material suitable for use with the disclosed assembly, including, but not limited to, aluminum, steel, composite, plastic, etc.

Referring to FIG. 1B, the sidewall 70 of the nutplate 15 includes an upper groove 72 and a lower groove 74 formed therein. The lower groove 74 seats a seal 79 that provides a seal between the nutplate 15 and the housing 13. The shape of the groove 74 can be any shape that is suitable for seating the seal 79.

The upper groove 72 has a substantially round C-shaped cross-section. In the assembled form, a flange 13c of the housing 13 proximate to the open end 13b of the housing 13 has a C-shaped groove 13d that conforms to the C-shaped upper groove 72 of the nutplate 15. The flange 13c has an outer surface 102 and an inner surface 104. The inner surface 104 of the flange 13c is in contact with a surface 111 of the upper groove 72.

Generally, the inner surface 104 of the flange 13c has discrete patterns of grooved and ungrooved areas defined by knurls and/or surface disruptions 115.

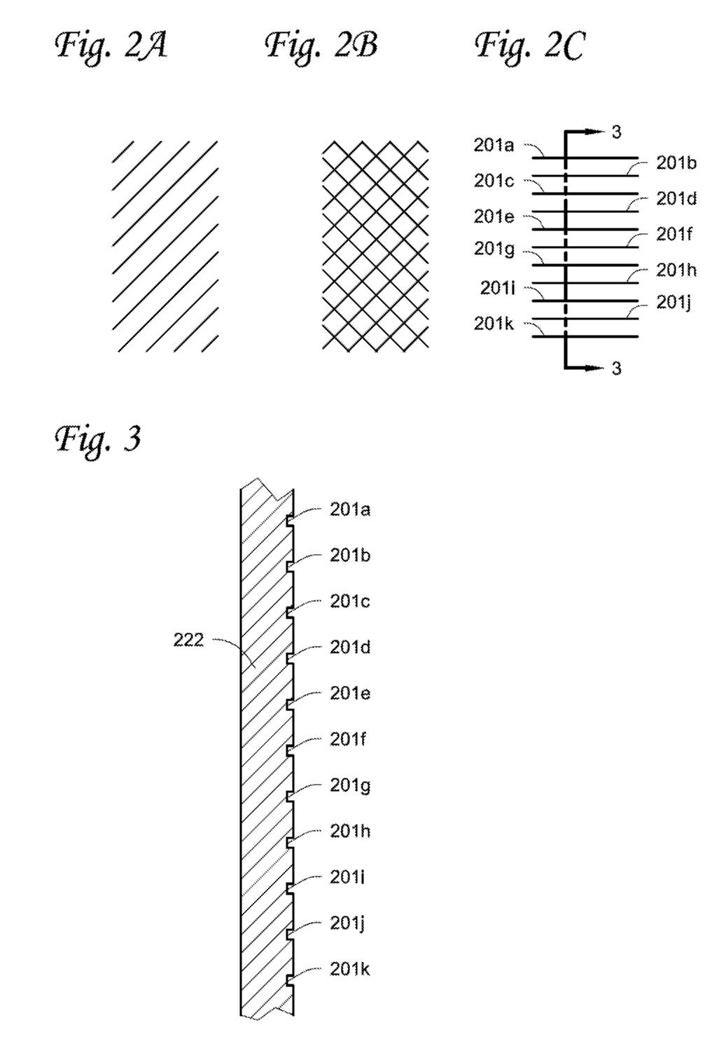

Examples of specific patterns of the knurls and/or surface disruptions 115 that can be utilized are illustrated in FIGS. 2A, 2B and 2C. As shown in these figures, the patterns of the knurls and/or surface disruptions 115 can be an angled pattern (FIG. 2A), a diamond pattern (FIG. 2B) or a straight pattern (FIG. 2C). The lines shown in FIGS. 2A, 2B, and 2C represent the grooved areas. In some examples, the knurls and/or surface disruptions 115 can be a plurality of surface disruptions, e.g., ridges, that are uniform in structure and are provided along the inner surface 104 of the flange 13c. In some examples, the ridges 115 are configured so as to not weaken the housing 13 but allow the ridges 115 on the inner surface 104 to embed or lock within a softer material of the nutplate 15.

The meaning of the grooved and ungrooved areas of the knurls and/or surface disruptions 115 will now be illustrated by way of the straight pattern shown in FIG. 2C. The straight pattern shown in FIG. 2C illustrates the pattern having grooves 201a, 201b, 201c, 201d, 201e, 201f, 201g, 201h, 201i, 201j and 201k. Referring to FIG. 3, this figure shows a cross sectional side view of the grooves 201a, 201b, 201c, 201d, 201e, 201f, 201g, 201h, 201i, 201j and 201k shown in FIG. 2C, with hatched area 222 representing the ungrooved area of the inner surface 104 of the flange 13c.

In FIGS. 2C and 3, eleven grooves are shown. However, the number of grooves can be any number that is suitable for gripping the surface 111 of the upper groove 72. Also, in FIG. 3, each of the grooves 201a, 201b, 201c, 201d, 201e, 201f, 201g, 201h, 201i, 201j and 201k is shown to he cup shaped as viewed in side view. However, it is to be realized that the shape and dimension of each the grooves 201a, 201b, 201c, 201d, 201e, 201f, 201g, 201h, 201i, 201j and 201k can be any shape or dimension that is suitable for gripping the surface 111 of the upper groove 72.

It is to be realized that in general, the pattern of the knurls and/or surface disruptions 115 can be any pattern having any dimension that is suitable for gripping the surface 111 of the upper groove 72, for example, to prevent rotation of the housing 13 relative to the nutplate 15.

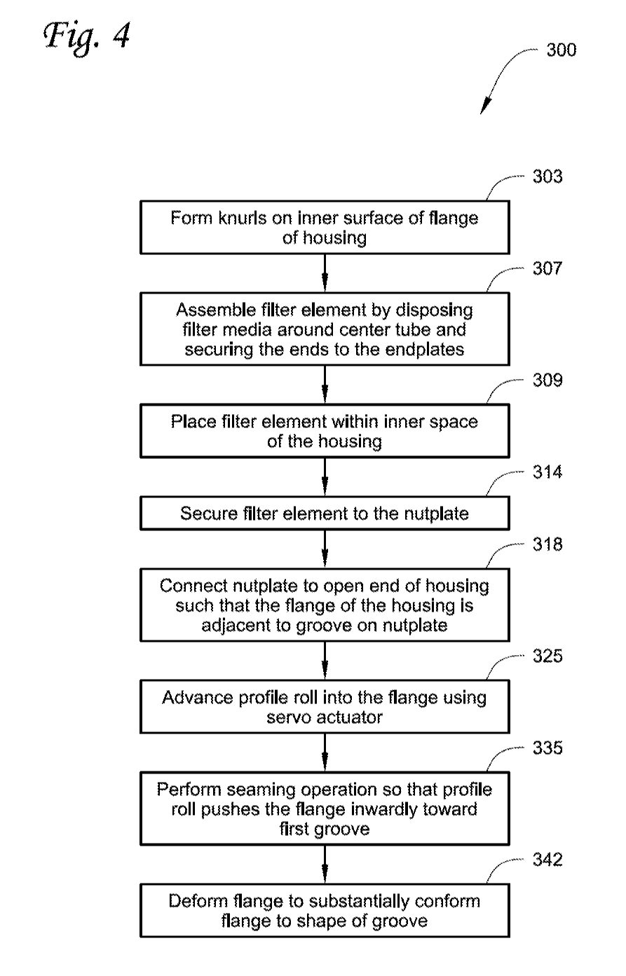

One embodiment of a method for forming the filter assembly 10 will now be described. Referring to FIG. 4, the disclosed method 300 involves forming knurls and/or surface disruptions 115 on the inner surface 104 of the flange 13c (step 303).

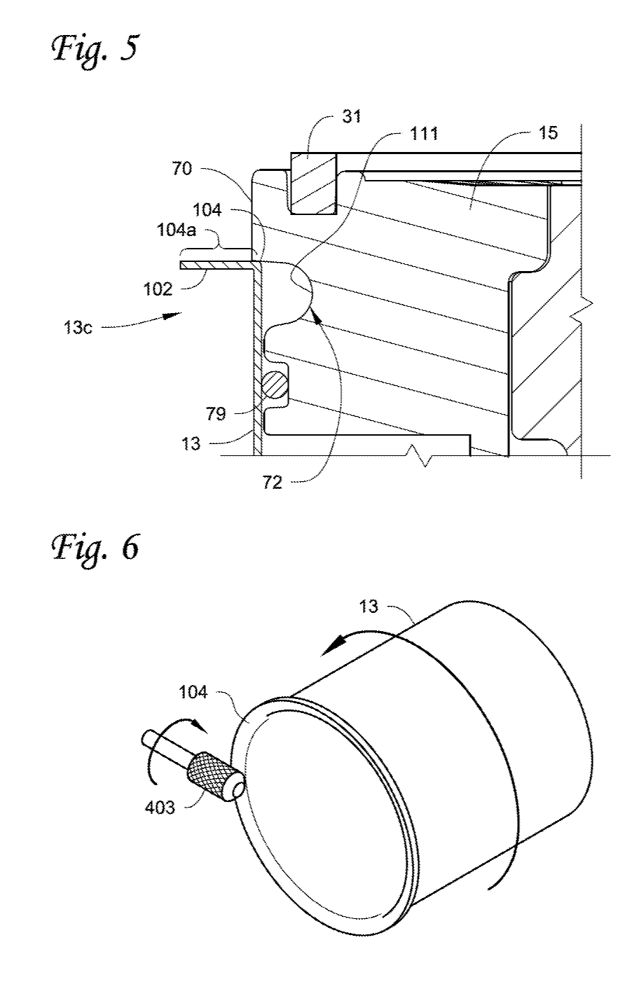

Referring to FIGS. 5 and 6, these figures show the state of the flange 13c of the housing 13 prior to deformation into the upper groove 72 of the nutplate 15. In particular, FIG. 5 illustrates a partial cross-sectional side view of the housing 13 and nutplate 15 before deformation. The flange 13c of the housing 13 is L-shaped, and the portion 104a of the inner surface 104 of the housing 13 is substantially flat.

FIG. 6 shows an example of a process used to form the knurls and/or surface disruptions 115 on the inner surface 104 of the housing 13. As shown in FIG. 6, a knurl wheel 403 having a grooved pattern can be used to form the pattern on the portion 104a of the inner surface 104 of the housing 13. Examples of the grooved pattern of the knurl wheel 403 are provided in FIGS. 7A, 7B, 7C, 7D and 7E. In some examples, the grooved pattern of the knurl wheel 403 can he used to form the discrete patterns of groove and ungrooved surfaces defined by the knurls and/or surface disruptions 115 as illustrated, for example, in FIGS. 2A, 2B and 2C.

The method further includes assembling the filter element 19 (step 307). The filter element 19 is assembled by disposing the filter media 30 around the center tube 35, and securing the ends 30a, 30b to the endplates 33, 37. The filter element 19 is then placed within the inner space 25 of the housing 13 (step 309). Once the filter element 19 is placed within the housing 13, the filter element 19 and the nutplate 15 are brought together by fitting the sleeve 64 of the filter element 19 within the central hub 50 of the nutplate 15 (step 314). The nutplate 15 then is connected to the open end 13b of the housing 13 such that a flange 13g of the housing 13 is adjacent to the upper groove 72 on the nutplate 15 (step 318).

In one implementation, a seamen machine is utilized for performing a seaming operation to radially deform the flange 13c so as to conform the flange 13c to the shape of the groove 72. In one example, a profile roll is advanced into the flange 13 using a servo actuator within the seamer machine (step 325). The seaming operation is then performed so that the profile roll pushes the flange 13c inwardly toward the groove 72 (step 335). The profile roll then deforms the flange 13c to substantially conform the flange 13c to the shape of the groove 72 (step 342). In some instances, the servo actuator is capable of following the shape of the groove 72 so as to embed the knurls and/or surface disruptions 115 into the surface 111 of the groove 72, thereby preventing free rotation of the housing 13 relative to the nutplate 15.

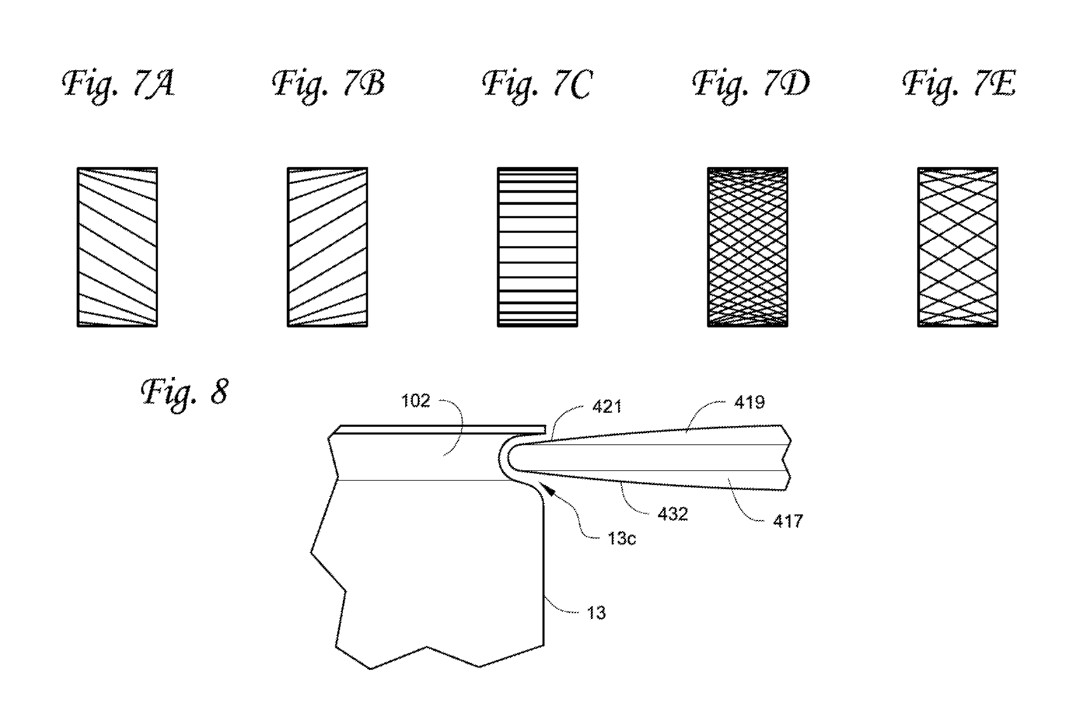

Referring to FIG. 8, a profile roll 417 that is used in the above described method can include knurl patterns 421 to form knurls and/or surface disruptions (not shown) on the outer surface 102 of the housing 13. FIG. 8 shows the knurl patterns 421 being formed on an upper face 419 of the profile roll 417. However, it is to be realized that the knurl patterns 421 can be formed on a lower surface 432 or both the upper surface 419 and the lower surface 432 of the profile roll 417.

The buds and/or surface disruptions that are formed on the outer surface 102 of housing 13 can be similar to those that are formed on the inner surface 104 of the housing 13 as described above. In some examples, the knurl patterns 421 on the profile roll 417 can be used to form the knurls and/or surface disruptions that are similar to those that are formed on the inner surface 104 of the housing 13 as described above. In some examples, the knurls and/or surface disruptions on the outer surface 104 of the housing eliminate the use of adhesives.

Advantageously, the disclosed method eliminates the need for a secondary operation to stake the housing to the nutplate, thereby allowing for a single machine process to produce a filter assembly with anti-rotation features.

While the disclosed filter assembly and methods have been described in conjunction with a preferred embodiment, it will be obvious to one skilled in the art that other objects and refinements of the disclosed filter assembly and methods may be made within the purview and scope of the disclosure.

The disclosure, in its various aspects and disclosed forms, is well adapted to the attainment of the stated objects and advantages of others. The disclosed details are not to be taken as limitations on the claims.

What is claimed is:

1. A filter assembly comprising:
a housing having an open end and an interior space;
a filter element including a filter media that is disposed in the interior space; and
a nutplate secured to the housing at the open end thereof,
wherein the filter assembly includes knurls and/or surface disruptions that are configured to prevent rotation of the housing relative to the nutplate.

2. The filter assembly of claim 1, wherein the nutplate includes fluid inlet openings that extend through the nutplate and direct fluid to be filtered into the interior space, and a hub having an opening through which filtered fluid exits the filter assembly, wherein the fluid inlet openings are disposed between the hub and a sidewall of the nutplate and the sidewall has a first groove formed therein.

3. The filter assembly of claim 2, wherein the housing includes a flange proximate to the open end, the flange having an inner surface and an outer surface and is disposed within the first groove so that the inner surface of the flange is in contact with a surface of the first groove, the inner surface of the flange having knurls and/or surface disruptions that are configured to prevent rotation of the housing relative to the nutplate.

4. The filter assembly of claim 3, wherein the outer surface of the flange includes knurls and/or surface disruptions.

5. The filter assembly of claim 2, wherein the sidewall includes a second groove formed therein that is axially spaced from the first groove, the second groove seating a seal for sealing between the nutplate and the housing.

6. The filter assembly of claim 1, wherein a pattern of the knurls and/or surface disruptions is an angled pattern, a diamond pattern or a straight pattern.

7. The filter assembly of claim 1, wherein the housing is cylindrical in shape.

8. The filter assembly of claim 1, wherein the filter media is configured to filter fuel, oil, or hydraulic fluid.

9. A method of forming a fluid filter assembly that includes a housing, a filter element and a nutplate, comprising:
forming knurls and/or surface disruptions that are configured to prevent rotation of the housing relative to the nutplate.

10. The method of claim 9, wherein the knurls and/or surface disruptions are formed on an inner surface of a flange of the housing, and the method further comprises connecting a nutplate to an open end of the housing such that the flange of the housing is adjacent to a groove on the nutplate and radially deforming the flange to conform the flange to the shape of the groove.

11. The method of claim 10, wherein a knurl wheel is used to form the knurls and/or surface disruptions on the inner surface of the flange.

12. The method of claim 11, wherein the knurl wheel includes a knurl pattern that is selected from an angled pattern, a diamond pattern and a straight pattern.

13. The method of claim 10, wherein radially deforming comprises rolling the flange using a profile roll.

14. The method of claim 13, wherein the profile roll includes a knurl pattern so as to form knurls and/or surface disruptions on an outer surface of the flange.

15. The method of claim 14, wherein the knurl pattern is selected from an angled pattern, a diamond pattern and a straight pattern.
